(19) United States
(12) Patent Application Publication
(10) Pub. No.: US 2010/0002624 A1
(43) Pub. Date: Jan. 7, 2010

(54) Wireless Communication Network System and Method

(75) Inventors: Ting-Yu Lin, Taipei (TW); Hsin-Hsiung Chiu, Taipei (TW); Kang-Lun Fan, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Arima Communication Corp., Taipei (TW)

(21) Appl. No.: 12/167,594

(22) Filed: Jul. 3, 2008

(51) Int. Cl. H04Q 7/00

(52) U.S. Cl. 370/328

(57) ABSTRACT

A system for wireless communication network is disclosed. The system includes several nodes and at least a gateway. Each of the nodes includes several first wireless network interface. Each of the first interfaces utilizes one of channels to send, receive or forward signals. Wherein the first interfaces of the same node utilize different and non-overlapping channels to send, receive or forward the signals at the same time. Each of the gateways includes a network interface and several second wireless network interfaces. The network interface connects to the Internet to receive or forward the signals. Each of the second wireless network interfaces utilizes one of the channels to receive or forward the signals. Wherein the second wireless network interfaces of the same gateway utilize different and non-overlapping channels to receive or forward the signals at the same time.

### BACKGROUND

1. Field of Invention

The present invention relates to a wireless communication network system and method. More particularly, the present invention relates to a wireless communication network system and method communicating with several interfaces through several channels.

2. Description of Related Art

FIG. 1 illustrates a conventional single-channeled wireless communication network system 10. Referring to FIG. 1, the single-channeled wireless communication network system 10 comprises several nodes 11, 12, 13 and a gateway 14. The node 11 has a wireless network interface 111, the node 12 has a wireless network interface 121, and the node 13 has a wireless network interface 131. The gateway 14 has a wireless network interface 141 and a network interface 142. The network interface 142 connects to the Internet 15. The wireless interfaces 111, 121, 131, 141 utilize a single channel ch1 to send, receive or forward signals. The channel ch1 follows IEEE 802.11 (such as 802.11 a/b/g). However, only one wireless network interface 111, 121, 131, 141 at a time can send signal to prevent collisions. Therefore, the bandwidth of the single-channeled wireless communication network system 10 is limited by the bandwidth of the channel ch1, which does not efficiently use the bandwidth between the network interface 142 and the Internet 15.

Above all, there is a need for a method and a system for a wireless communication network to utilize the bandwidth between the gateway and Internet efficiently.

### SUMMARY

A wireless communication network system is provided. The wireless communication network system includes several nodes and at least one gateway. Each of the nodes has several first wireless network interfaces. Each of the first interfaces utilizes one of channels to send, receive or forward signals. The first interfaces of the same node utilize different and non-overlapping channels to send, receive or forward the signals at the same time. Each of the gateways includes a network interface and several second wireless network interfaces. Each of the network interfaces connects to the Internet to receive or forward the signals. Each of the second wireless network interfaces utilizes one of the channels to receive or forward the signals. The second wireless network interfaces of the same gateway utilize different and non-overlapping channels to receive or forward the signals at the same time.

A wireless communication network method is also disclosed. The wireless communication network method includes the following steps. A process unit of a device assigns some of wireless network interfaces of the device to send the signals at the same time through different and non-overlapping channels. The process unit assigns some of the wireless network interfaces to forward the signals at the same time through different and non-overlapping channels.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a conventional single-channeled wireless communication network system;

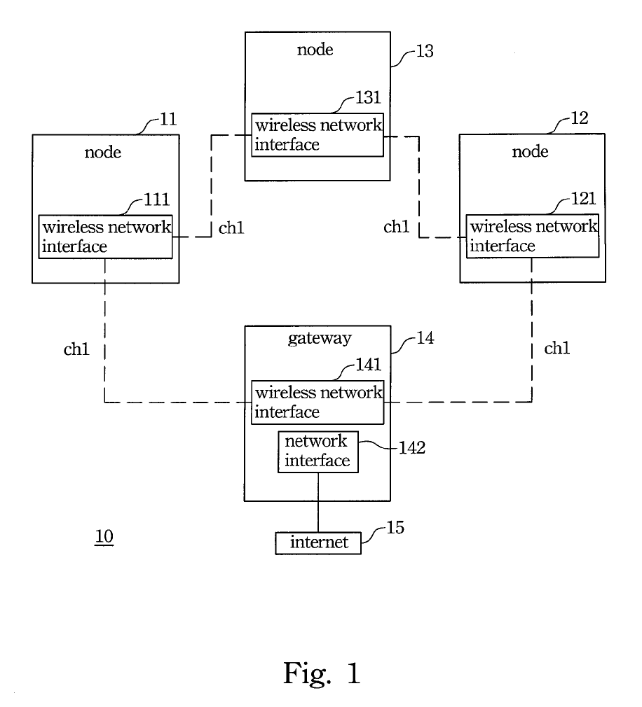

FIG. 2 illustrates a multi-channeled wireless communication network system according to a first embodiment of this invention;

FIG. 3 illustrates a multi-channeled wireless communication network system according to a second embodiment of this invention; and

FIG. 4 is a flow diagram of a multi-channeled wireless communication network method according to a third embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

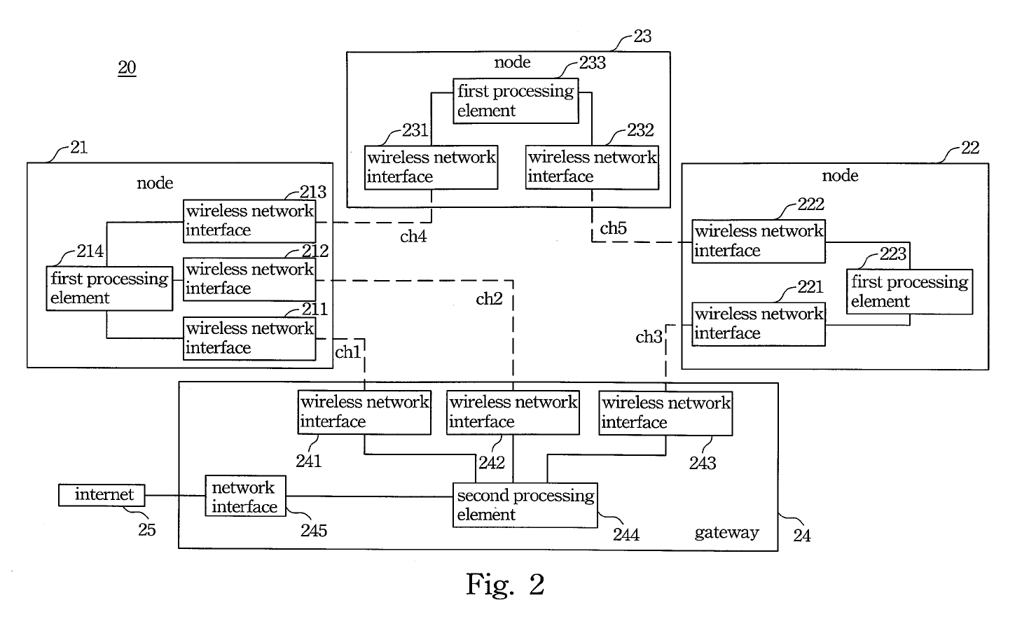

FIG. 2 illustrates a multi-channeled wireless communication network system 20 according to a first embodiment of this invention. Referring to FIG. 2, the multi-channeled wireless communication network system 20 comprises several nodes 21, 22, 23 and a gateway 24. The node 21 comprises several wireless network interfaces 211, 212, 213 and a first process unit 214. The node 22 comprises several wireless network interfaces 221, 222 and a first process unit 223. The node 23 comprises several wireless network interfaces 231, 232 and a first process unit 233. The gateway comprises several wireless network interfaces 241, 242, 243, a second process unit 244 and a network interface 245. Channels ch1, ch2, ch3, ch4 and ch5 can transmit the signals in the multi-channeled wireless communication network system 20. Wherein the channels ch1, ch2, ch3, ch4 and ch5 follow IEEE 802.11 (such as 802.11 a/b/g). Also, the channels ch1, ch2, ch3, ch4 and ch5 are non-overlapping.

The first process unit 214 connects to the wireless network interfaces 211, 212, 213 respectively. The first process unit 223 connects to the wireless network interfaces 221 and 222 respectively. The first process unit 233 connects to the wireless network interfaces 231 and 232 respectively. The second process unit 244 connects to the wireless network interfaces 241, 242 and 243 and the network interface 245. The network interface 245 connects to the Internet 25. The network interface 245 connects to the Internet through a cable modem, Asymmetric Digital Subscribe Line (ADSL), Integrated Services Digital Network (ISDN), T1, T2, T3, T4, E1, or Fiber Optical Network.

The wireless network interfaces 211, 212, 213, 221, 222, 231 and 232 send, receive or forward signals through channels ch1, ch2, ch3, ch4 and ch5. The wireless network interfaces 241, 242 and 243 receive or forward signals through the channels ch1, ch2, ch3, ch4 and ch5. The wireless network interfaces 211, 212, 213, 221, 222, 231, 232, 241, 242 and 243 can transmit signals to each other utilizing the same channel.

The first process unit 214 assigns the wireless network interfaces 211, 212 and 213 to send, receive or forward signals. The first process unit 223 assigns the wireless network interfaces 221 and 222 to send, receive or forward signals. The first process unit 233 assigns the wireless network interfaces 231 and 232 to send, receive or forward signals. The second process unit 244 assigns the wireless network interfaces 241, 242 and 243 to receive or forward signals. Therefore, the signals of the nodes 21, 22 and 23 or the gateway 24 can be transmitted at the same time through several wireless network interfaces by the assignment. For example, the signals of the node 21 can be transmitted by the wireless network interfaces 211 and 212 at the same time to the gateway 24 through the assignment of the first process unit 214.

Also, the channels ch1, ch2, ch3, ch4 and ch5 can be assigned previously to the wireless network interfaces 211, 212, 213, 221, 222, 231, 232, 241, 242 and 243 to maximize the bandwidth of the multi-channeled wireless communication network system 20. Therefore, the bandwidth of the network interface 245 can be utilized more efficiently. Take FIG. 2 for example, since the channels ch1, ch2, ch3, ch4 and ch5 are non-overlapping, the channels ch1, ch2, ch3, ch4 and ch5 can transmit the signals at the same time. Therefore, the maximum wireless network bandwidth of the multi-channeled wireless communication network system 20 is the total bandwidth of the channels ch1, ch2, ch3, ch4 and ch5.

In the first embodiment, the multi-channeled wireless communication network system comprises several nodes and a gateway. Each of the nodes disposes several wireless network interfaces to transmit signals through several channels at the same time. The gateway disposes several wireless network interfaces to transmit the signals through different channels. Therefore, the bandwidth of the multi-channeled wireless communication network system increases, which makes the bandwidth between the gateway and Internet utilized efficiently.

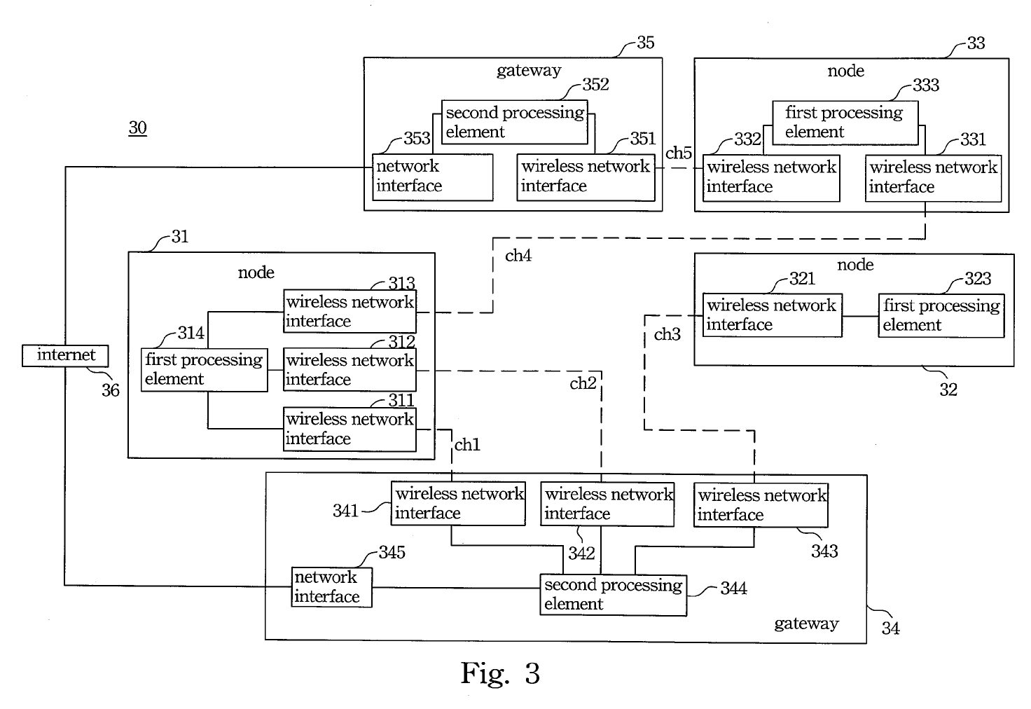

FIG. 3 illustrates a multi-channeled wireless communication network system 30 according to a second embodiment of this invention. Referring to FIG. 3, the multi-channeled wireless communication network system 30 comprises several nodes 31, 32, 33 and several gateways 34, 35. The node 31 comprises several wireless network interfaces 311, 312, 313 and a first process unit 314. The node 32 comprises a wireless network interface 321 and a first process unit 323. The node 33 comprises several wireless network interfaces 331, 332 and a first process unit 333. The gateway 34 comprises several wireless network interfaces 341, 342 and 343, a second process unit 344 and a network interface 345. The gateway 35 comprises a wireless network interface 351, a second process unit 352 and a network interface 353. Channels ch1, ch2, ch3, ch4 and ch5 can transmit the signals in the multi-channeled wireless communication network system 30. The channels ch1, ch2, ch3, ch4 and ch5 follow IEEE 802.11 (such as 802.11 a/b/g). Also, the channels ch1, ch2, ch3, ch4 and ch5 are non-overlapping.

The first process unit 314 connects to the wireless network interfaces 311, 312, 313 respectively. The first process unit 323 connects to the wireless network interfaces 321. The first process unit 333 connects to the wireless network interfaces 331, 332 respectively. The second process unit 344 connects to the wireless network interfaces 341, 342, 343 and the network interface 345. The second process unit 352 connects to the wireless network interface 351 and the network interface 353. The network interfaces 345 and 353 connect to the Internet 36. The network interfaces 345 and 353 connect to the Internet through cable modem, Asymmetric Digital Subscribe Line (ADSL), Integrated Services Digital Network (ISDN), T1, T2, T3, T4, E1, or Fiber Optical Network.

The wireless network interfaces 311, 312, 313, 321, 331 and 332 send, receive or forward signals through channels ch1, ch2, ch3, ch4 and ch5. The wireless network interfaces 341, 342, 343 and 351 receive or forward signals through the channels ch1, ch2, ch3, ch4 and ch5. The wireless network interfaces 311, 312, 313, 321, 331, 332, 341, 342, 343 and 351 can transmit signals to each other utilizing the same channel.

The first process unit 314 assigns the wireless network interfaces 311, 312 and 313 to send, receive or forward signals. The first process unit 323 assigns the wireless network interface 321 to send, receive or forward signals. The first process unit 333 assigns the wireless network interfaces 331, 332 to send, receive or forward signals. The second process unit 344 assigns the wireless network interfaces 341, 342, 343 to receive or forward signals. The second process unit 352 assigns the wireless network interface 351 to receive or forward signals. Therefore, the signals of the nodes 31, 32 and 33 or the gateways 34 and 35 can be transmitted at the same time through several wireless network interfaces by the assignment. For example, the signals of the node 31 can be transmitted by the wireless network interfaces 311, 312 to the gateway 34 at the same time through the assignment of the first process unit 314.

Also, the channels ch1, ch2, ch3, ch4 and ch5 can be assigned previously to the wireless network interfaces 311, 312, 313, 321, 331, 332, 341, 342, 343 and 351 to maximize the bandwidth of the multi-channeled wireless communication network system 30. Therefore, the bandwidth of the network interfaces 345 and 353 can be utilized more efficiently. Take FIG. 3 for example, since the channels ch1, ch2, ch3, ch4 and ch5 are non-overlapping, the channels ch1, ch2, ch3, ch4 and ch5 can be utilized to transmit the signals at the same time. Therefore, the maximum wireless network bandwidth of the multi-channeled wireless communication network system 30 is the total bandwidth of the channels ch1, ch2, ch3, ch4 and ch5.

In the second embodiment, the multi-channeled wireless communication network system comprises several nodes and several gateways. Each of the nodes disposes several wireless network interfaces to transmit signals through several channels at the same time. Each of the gateways disposes several wireless network interfaces to transmit the signals through different channels. Therefore, the bandwidth of the multi-channeled wireless communication network system increases, which makes the bandwidth between the gateways and Internet utilized efficiently.

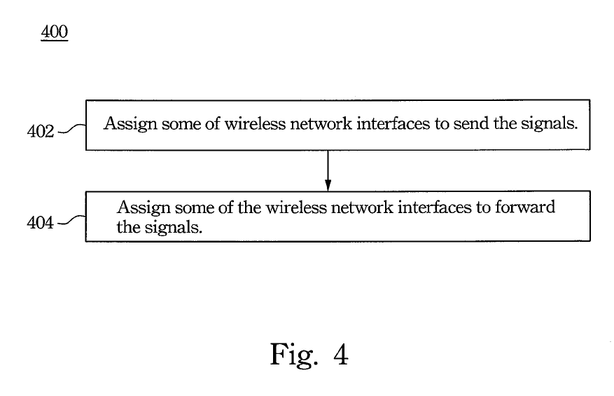

FIG. 4 is a flow diagram of a multi-channeled wireless communication network method 400 according to a third embodiment of this invention. The multi-channeled wireless communication network method 400 begins with the step 402 in which a process unit of a device assigns some of wireless network interfaces to send signals at the same time through different and non-overlapping channels. In the step 404, the process unit assigns some of the wireless network interfaces to forward the signals at the same time through different and non-overlapping channels. Wherein, the device may be a node or a gateway with several wireless network interfaces.

In the third embodiment, the signals of the device are assigned to several wireless network interfaces. Besides, since the assignment of the signals is much faster than the wireless network transmission rate, the signals can be transmitted by several wireless interfaces assigned by the process unit through different channels at the same time. Therefore, increase the transmission rate of the signals.

Above all, each of nodes or gateways disposes several wireless network interfaces. In addition to assignment of wireless network interfaces, signals can be transmitted by several wireless network interfaces through several channels at the same time.

Although the present invention has been described in considerable detail with reference to certain embodiments thereof, other embodiments are possible. Therefore, their spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A wireless communication network system, comprising:
a plurality of nodes, wherein each of the nodes has at least a first wireless network interface, each of the first wireless network interface utilizes one of a plurality of channels to send, receive or forward a plurality of signals, and the first wireless network interface of the same node utilizes different and non-overlapping channels to send, receive or forward the signals at the same time; and
at least a gateway, wherein each of the gateway comprises:
a network interface connecting to the Internet to receive or forward the signals; and
at least a second wireless network interface, wherein each of the second wireless network interface utilizes one of the channels to receive or forward the signals, and the second wireless network interface of the same gateway utilizes different and non-overlapping channels to receive or forward the signals at the same time.

2. The wireless communication network system of claim 1, wherein each of the nodes further comprises a first process unit connecting to the first wireless network interface, and each of the first process units assigns at least one of the first wireless network interfaces to send, receive or forward the signals at the same time.

3. The wireless communication network system of claim 1, wherein each of the gateway further comprises a second process unit connecting to the second wireless network interface, and the second process unit assigns at least one of the second wireless network interface to receive or forward the signals at the same time.

4. The wireless communication network system of claim 1, wherein the network interface connects to the Internet through Cable Modem, Asymmetric Digital Subscribe Line (ADSL), Integrated Services Digital Network (ISDN), T1 Line, T2 Line, T3 Line, T4 Line, E1 Line, or Fiber Optical Network.

5. The wireless communication network system of claim 1, wherein the channels follow 802.11.

6. The wireless communication network system of claim 1, wherein the channels follow 802.11a, 802.11b, or 802.11g.

7. A wireless communication network method, comprising the steps of:
a process unit of a device assigns some of wireless network interfaces of the device to send the signals at the same time through different and non-overlapping channels; and
the process unit assigns some of the wireless network interfaces to forward the signals at the same time through the different and non-overlapping channels.
